(19) United States
(12) Patent Application Publication
(10) Pub. No.: US 2014/0161195 A1
(43) Pub. Date: Jun. 12, 2014

(54) VIDEO GENERATOR - USE OF DATABASE FOR VIDEO, IMAGE, GRAPHICS AND AUDIO

(71) Applicant: GURULOGIC MICROSYSTEMS OY, Turku (FI)

(72) Inventors: Tuomas Kärkkäinen, Turku (FI); Ossi Mikael KALEVO, Toijala (FI)

(73) Assignee: GURULOGIC MICROSYSTEMS OY, Turku (FI)

(21) Appl. No.: 13/715,405

(22) Filed: Dec. 14, 2012

(30) Foreign Application Priority Data
Dec. 11, 2012 (GB) 1222240.2

(51) Int. Cl. H04N 7/26

(52) U.S. Cl. CPC H04N 19/00; H04N 19/00533
USPC 375/240.25; 375/240.01

(57) ABSTRACT

A method of encoding source data to generate corresponding encoding data for transmission or storage is provided, wherein the method includes:
(a) matching one or more portions of the source data to one or more elements in one or more databases, wherein the one or more elements are representative of corresponding one or more data blocks, and recording reference values which relate the one or more portions of the source data to the one or more matched elements; and
(b) including the reference values in the encoded data together with the one or more databases and/or information identifying the one or more databases.
   A similar method of decoding encoded data to generate corresponding decoded output data is also provided is also described. The methods are beneficially implemented in an encoder, a decoder and in a codec.

### CROSS REFERENCE TO RELATED APPLICATIONS

This application claims the benefit under 35 U.S.C. §119(a) and 37 CFR 1.55 to UK Patent Application No. 1222240.2, filed on Dec. 11, 2012, the entire content of which is hereby incorporated by reference.

### FIELD OF THE INVENTION

The present invention relates to encoders for encoding source data for generating corresponding encoded data; moreover, the present invention relates to decoders for decoding the encoded data to generate corresponding decoded data representative of the source data; the encoders and the decodes are operable to employ one or more databases which include information which is processed in combination with the encoded data at the decoders for generating the decoded data. Moreover, the present invention concerns methods of encoding source data to generate corresponding encoded data; moreover the present invention concerns methods of decoding the encoded data for generating decoded data representative of the source data; the methods including utilizing one or more databases which include information which is processed in combination with the encoded data to generate the decoded data. Furthermore, the present invention relates to software products recorded on machine-readable data storage media, wherein the software products are executable upon computing hardware for implementing aforementioned methods.

### BACKGROUND OF THE INVENTION

Conventionally, encoding source data, for example via contemporary MPEG encoding, involves processing the source data to transform the source data into encoded data by applying one or more transforms to the source data, and decoding the encoded data involves processing the encoded data to transform the encoded data to decoded data representative of the source data by applying one or more inverse transforms to the encoded data. Such encoding can be employed for compressing the source data, for example for reducing its data size for transmission or storage on a data carrier; alternatively, or additionally, such encoding can be employed to increase security of the source data when being transmitted through a transmission medium, for example via the Internet. It is conventional practice to implement such encoders and decoders as self-contained processing units, for example embedded in digital cameras, DVD payers and similar consumer products. However, with greater contemporary interconnectivity of data processing devices, it has become a more recent practice to design encoders and decoders to be implemented using software products so that they can be reconfigured, for example for adapting the decoders to cope with encoded data which has been encoded using encoding transforms which have been recently evolved and upgraded.

In a published U.S. Pat. No. 4,553,171, there is described a method of digitally printing a digital image by reference to a succession of code words representing blocks of pixels of an original image. The original picture is encoded by subdividing it into uniform size blocks of pixels. Each of the blocks of pixels is given a unique identifier unless it is identical to any of the previously scanned blocks. Identical blocks of pixels are given the same identifier. When printing the original image as represented by aforesaid blocks of pixels as represented by identifiers expressed as code words, the identifiers are scanned in sequence and the corresponding pixel blocks are successively stored in buffer memories to modulate the printer which generates a printout of the original image. Thus, the original image is printed from data including identifiers comprising block index numbers that refer to a form of database storing representations of the pixel blocks.

In a U.S. Pat. No. 4,013,828, there is described a method of processing an image, wherein the image is scanned and dither-processed in picture element groups of predetermined size. Each picture element group corresponds to a corresponding group of cells of a remotely-located display panel. As each picture element group is scanned, a pattern represented by corresponding dithered image bits to the picture element group is compared to a dictionary of patterns stored in a first memory. If the pattern is not among those stored in the first memory, it is assigned an associated code word and is entered into the memory. Moreover, both the pattern and its code word are transmitted to the remotely-located display panel where they are stored in a second memory; the second memory is then accessed and individual cells of a cell group corresponding to the scanned picture are energized in accordance with the pattern stored in the second memory. If a scanned pattern is the same as one already stored in the first memory, only that code word associated with that pattern is transmitted to the remote location for achieving a reduction in data flow between the first memory and the second memory, namely by reusing data already transferred to the second memory. However, the method does not directly compress the data flow in a conventional sense.

In a published United Kingdom patent no, GB 2362055, there is described a method coding an image, wherein the method includes:
(a) dividing the image into image blocks;
(b) encoding the image blocks is such a way that the image blocks are compared with already existing blocks in a database, and choosing an existing block from the database which is a good enough match to a corresponding one amongst the image blocks; and
(c) coding the image blocks with reference to codes representative of the already existing blocks.
   The method employs a code library, namely a database. However, on account of data in association with the database elements not having any connection with each other, performing searches in the database to find matches is difficult and requires considerable computing resources as the size of the database is increased. Conversely, when the database is small, matching of the image blocks to the already existing blocks in the database is compromised, with a result that an image cannot be constructed from coded data generated by the method to a sufficient degree of quality. However, the method includes creating new elements if sufficiently good matches are not found, wherein the new element is transmitted together with a reference value which identified it.

The usage of digital data, for example video, image, graphics and audio, is rapidly increasing as every year passes. On account of such usage, the amount of data being stored and transmitted has also increased rapidly as a function of progressing time. Moreover, such increase in data being stored and transmitted requires increasingly more resources for hardware devices, for example more electrical power consumed for providing more processing capacity and larger communication transmission bandwidths. An image generator as described in a published United States patent application no. US 2010/322,301 (Gurulogic Microsystems Oy) defines a technical solution which addresses how to save bytes and generate varying images by using a database. However, the is a need for an encoder, and corresponding decoder, based upon the use of a database, which is operable to deliver many different types of databases in a more efficient manner, for use with all kinds of digital data, for example images, video, graphics and audio content.

### SUMMARY OF THE INVENTION

An object of the present invention is to provide an improved method of encoding source data to generate corresponding encoded output data, and also an encoder operable to implement the method of encoding source data.

Moreover, another object of the present invention is to provide an improved method of decoding encoded data to generate corresponding decoded output data.

According to a first aspect of the present invention, there is provided a method of encoding source data as claimed in appended claim 1: there is provided a method of encoding source data to generate corresponding encoding data for transmission or storage, characterized in that the method includes:
(a) matching one or more portions of the source data to one or more elements in one or more databases, wherein the one or more elements are representative of corresponding one or more data blocks, and recording reference values which relate the one or more portions of the source data to the one or more matched elements; and
(b) including the reference values in the encoded data together with the one or more databases and/or information identifying the one or more databases.

The present invention is of advantage in that the invention provides for a codec which is capable of achieving superior video, image graphics and audio decoded content quality, whilst using fewer data bits to be communicated in comparison to known contemporary codecs.

Optionally, in the method, the source data includes at least one of: audio, video, graphics, multi-dimensional data. Optionally, the multi-dimensional data is generated by combining data of lesser dimensions; for example, three-dimensional-data can include a plurality of sets of two-dimensional data.

Optionally, the method includes;
(c) receiving the source data in a form of one or more data blocks, dividing the one or more data blocks into areas having a predetermined size and a unique area identifier;
(d) taking area-specific samples from the areas of the one or more data blocks and computing corresponding reference values (R) on a basis of the samples;
(e) storing into a memory or transmitting the reference values (R) for an area and a corresponding area-identifier in an area-specific manner; and
(f) checking whether the reference values (R) obtained as a result of the computations applied to the one or more images have already been stored in the memory or transmitted, and storing into the memory or transmitting the computed reference values (R) and the corresponding area-identifiers for which reference values (R) have been computed in an event that the reference values (R) and the corresponding area-identifiers have not previously been stored into the memory.
   More optionally, the one or more data blocks correspond to one or more images in the source data.

Moreover, the present invention provides benefits of decreased data size in data storage, for example in data memory, data carrier and similar, which saves computational resources, electrical power consumption and data loading time.

Furthermore, ISP's around the World can, by employing the present invention, can provide faster static database servers in client LAN's, thereby enabling more efficient data transfer to be achieved, because only a small amount of new data blocks are sent, and existing database reference data blocks are received from a static database server in the LAN.

Optionally, in the method, the one or more databases include one or more static databases and/or one or more dynamic databases. More optionally, the method utilizes at least one of:
(a) the one or more static databases are generated by selecting elements from one or more dynamic databases;
(b) information present in the one or more portions of the source data is processed to generate one or more elements (E) for inclusion in the one or more dynamic databases; and
(c) selecting elements (E) from one or more earlier dynamic databases and including them in the one or more dynamic databases for use with the encoded data.

Optionally, in the method, the reference values (R) include multiple parts which are separately encoded for inclusion in the encoded data. More optionally, in the method, one or more of the multiple parts are combined before being encoded for inclusion in the encoded data. Optionally, the multiple parts relate to variance V, mean M and amplitude A characteristics of one or more data blocks accessed via use of the reference value (R).

Optionally, in the method, the reference values (R) include information for guiding searching of correspond one or more elements (E) in the one or more databases.

Optionally, in the method, the one or more elements (E) include one or more parameters from which one or more corresponding data blocks can be computed by interpolation.

Optionally, in the method, the one or more dynamic databases are created for a limited time duration, after which they are erased.

Optionally, the method includes restructuring one or more of the databases as a function of a frequency of accessing elements (E) within the databases for rendering more frequently accessed elements (E) faster to access using the reference values (R).

Optionally, in the method, elements (E) of the one or more dynamic databases are generated when matches of the one or more portions of the source data with one or more elements (E) in the one or more static databases cannot be found.

Optionally, in the method, matching of the one or more portions of the source data with one or more elements (E) of the one or more databases is made to within a quality threshold, wherein the quality threshold is dynamically altered during generation of the reference values (R).

Optionally, in the method, the one or more reference values (R) are used to reconstruct one or more corresponding portions of the source data using one or more elements (E) defined by the one or more reference values (R), and wherein errors are determined between the reconstructed one or more portions and corresponding original one or more portions in the source data, and the errors are encoded and included in the encoded data.

Optionally, in the method, the one or more data blocks corresponding to the one or more elements (E) are at least one of: 1-D, 2-D or 3-D, polygonal when visually displayed, rectangular when visually displayed, elliptical when visually displayed, circular when visually displayed, elongate when visually displayed, triangular when visually displayed.

Optionally, in the method, one or more elements (E) of a first database are operable to refer to one or more elements (E) present in one or more other of the one or more databases. In other words, an element (E) in a first database can refer to an element (E) in a second database from which a corresponding data block is derived.

Optionally, in the method, one or more reference values (R) included in the encoded data are in compressed form.

Optionally, in the method, the one or more databases are selected and/or are varied in size depending upon a nature of content present in the source data.

According to a second aspect of the present invention, there is provided an encoder for encoding source data to generate corresponding encoding data, characterized in that the encoder includes:
(a) first data processing hardware for matching one or more portions of the source data to one or more elements (E) in one or more databases, wherein the one or more elements (E) are representative of corresponding one or more data blocks, and recording reference values (R) which relate the one or more portions of the source data to the one or more matched elements (E); and
(b) second data processing hardware for including the reference values (R) in the encoded data together with the one or more databases and/or information identifying the one or more databases.

Optionally, the encoder is operable:
(c) to receive the source data in a form of one or more images, to divide the one or more images into areas having a predetermined size and a unique area identifier;
(d) to take area-specific samples from the areas of the one or more images and to compute corresponding reference values (R) on a basis of the samples;
(e) to store into a memory or to transmit the reference values (R) for an area and a corresponding area-identifier in an area-specific manner; and
(f) to check whether the reference values (R) obtained as a result of the computations applied to the one or more images have already been stored in the memory or transmitted, and to store into the memory or to transmit the computed reference values (R) and the corresponding area-identifiers for which reference values (R) have been computed in an event that the reference values (R) and the corresponding area-identifiers have not previously been stored into the memory.

Optionally, in the encoder, the one or more databases include one or more static databases and/or one or more dynamic databases.

Optionally, the encoder utilizes at least one of:
(a) the one or more static databases are generated by selecting elements from one or more dynamic databases;
(b) information present in the one or more portions of the source data is processed to generate one or more elements (E) for inclusion in the one or more dynamic databases; and
(c) selecting elements (E) from one or more earlier dynamic databases and including them in the one or more dynamic databases for use with the encoded data.

More optionally, in the encoder, first data processing hardware is operable to generate the reference values (A) to include multiple parts which are separately encoded for inclusion in the encoded data. More optionally, the encoder is operable to combine one or more of the multiple parts before encoding them for inclusion in the encoded data.

Optionally, in the encoder, the reference values (R) include information for guiding searching of correspond one or more elements (E) in the one or more databases.

parameters from which one or more corresponding data blocks can be computed by interpolation.

Optionally, in the encoder, the one or more dynamic databases are created for a limited time duration, after which they are erased.

Optionally, the encoder is operable to restructure one or more of the databases as a function of a frequency of accessing elements (E) within the databases for rendering more frequently accessed elements (E) faster to access using the reference values (R).

Optionally, in the encoder, elements (E) of the one or more dynamic databases are generated when matches of the one or more portions of the image with one or more elements (E) in the one or more static databases cannot be found.

Optionally, in the encoder, matching of the one or more portions of the source data with one or more elements of the one or more databases is made by the first data processing hardware to within a quality threshold, wherein the quality threshold is dynamically altered during generation of the reference values.

Optionally, in the encoder, the first data processing hardware is operable to use the one or more reference values (R) to reconstruct one or more corresponding portions of the source data using one or more elements (E) defined by the one or more reference values (R), and wherein the first data processing hardware is operable to identify errors between the reconstructed one or more portions and corresponding original one or more portions in the source data, and the second data processing hardware is operable to encode the errors and included them in the encoded data.

Optionally, in the encoder, the one or more data blocks corresponding to the one or more elements (E) are at least one of: 1-D, 2-D or 3-D, polygonal when visually displayed, rectangular when visually displayed, elliptical when visually displayed, circular when visually displayed, elongate when visually displayed, triangular when visually displayed.

Optionally, in the encoder, one or more elements (E) of a first database are operable to refer to one or more elements (E) present in one or more other of the one or more databases.

Optionally, in the encoder, one or more reference values (R) included in the encoded data are in compressed form.

Optionally, in the encoder, the first data processing hardware is operable to select the one or more databases depending upon a nature of content present in the source data.

According to a third aspect of the present invention, there is provided a method of decoding encoded data to generate corresponding decoded output data, characterized in that the method includes:
(a) receiving encoded data including reference values (R) and information regarding one or more databases;
(b) decoding from the encoded data the reference values (R);
(c) accessing one or more elements (E) from the one or more databases as directed by the reference values (R), wherein the one or more elements (E) are representative of one or more corresponding data blocks; and
(d) generating the one or more data blocks for assembling corresponding decoded data for output.

Optionally, the method includes:
(e) maintaining in a memory reference values (R) and data block information corresponding to the reference values (R);
(f) receiving or retrieving from a memory area identifiers and a reference value (R) corresponding to each area identifier;
(g) retrieving from the memory on the basis of the reference value (R) of each area identifier data block information corresponding to the reference value (R); and
(h) generating, on the basis of the data block information retrieved from the memory, a part of a data block to a data block area indicated by the area identifier, on the basis of the reference value (R) corresponding to said area identifier.
   More optionally, the one or more data blocks correspond to one or more images in the source data.

Optionally, in the method, the one or more databases include one or more static databases and/or one or more dynamic databases.

Optionally, in the method, the one or more databases are spatially disposed locally to data processing hardware arranged to execute the method. More optionally, in the method, the one or more databases are hosted in a LAN which also includes the data processing hardware.

Optionally, the method includes generating one or more dynamic databases from one or more elements (E) of the one or more static databases and/or from information provided in the encoded data, wherein the generated one or more dynamic databases are employed for decoding the encoded data.

Optionally, the method includes generating from the one or more elements (E) corresponding one or more data blocks which are at least one of: 1-D, 2-D or 3-D, polygonal when visually displayed, rectangular when visually displayed, elliptical when visually displayed, circular when visually displayed, elongate when visually displayed, triangular when visually displayed.

According to a fourth aspect of the present invention, there is provided a decoder for decoding encoded data to generate corresponding decoded data, characterized in that the decoder includes:
(a) first data processing hardware for receiving encoded data including reference values and information regarding one or more databases;
(b) second data processing hardware for decoding from the encoded data the reference values;
(c) third data processing hardware for accessing one or more elements from the one or more databases as directed by the reference values, wherein the one or more elements are representative of one or more corresponding data blocks; and
(d) fourth data processing hardware for generating the one or more data blocks for assembling corresponding decoded data for output.

Optionally, the decoder is configured:
(e) to maintain in a memory reference values (R) and data block information corresponding to the reference values:
(f) to receive or to retrieve from a memory area identifiers and a reference value corresponding to each area identifier;
(g) to retrieve from the memory on the basis of the reference value (R) of each area identifier data block information corresponding to the reference value (R); and
(h) to generate, on the basis of the data block information retrieved from the memory, a part of a data block to a data block area indicated by the area identifier, on the basis of the reference value (R) corresponding to said area identifier.
   More optionally, the one or more data blocks correspond to one or more images in the source data.

Optionally, in the decoder, the one or more databases include one or more static databases and/or one or more dynamic databases.

Optionally, in the decoder, the one or more databases are spatially disposed locally to the data processing hardware of the decoder. More optionally, in the decoder, the one or more databases are hosted in a LAN which also includes the data processing hardware of the decoder. Alternatively, or additionally, the one or more databases are located at the decoder, for example in its data memory (RAM, ROM).

Optionally, the decoder is operable to generate one or more dynamic databases from one or more elements (E) and/or one or more static databases and/or from information provided in the encoded data, wherein the one or more generated dynamic databases are employed for decoding the encoded data to generate the corresponding decoded data.

Optionally, the decoder is operable to generate the one or more data blocks from the one or more elements (E), wherein the one or more data blocks are at least one of: 1-D, 2-D or 3-D, polygonal when visually displayed, rectangular when visually displayed, elliptical when visually displayed, circular when visually displayed, elongate when visually displayed, triangular when visually displayed.

According to a fifth aspect of the present invention, there is provided a codec including at least one encoder pursuant to the second aspect of the invention for encoding source data to generate corresponding encoded data, and at least one decoder pursuant to the fourth aspect of the invention for receiving the encoded data and for decoding the encoded data to generate corresponding decoded data.

Optionally, the codec is incorporated into one or more consumer electronics products, for example personal computers (PC), video recorders, video players, smart telephones, scientific equipment, medical equipment, surveillance apparatus, security apparatus and digital cameras.

Optionally, the codec is implemented such that the at least encoder and the at least one decoder share one or more databases referred to by reference values included in the encoded data.

According to a sixth aspect of the present invention, there is provided a software product recorded on machine-readable data storage media, characterized in that the software product is executable on computing hardware of an encoder for implementing a method pursuant to the first aspect of the invention.

According to a seventh aspect of the present invention, there is provided a software product recorded on machine-readable data storage media, characterized in that the software product is executable on computing hardware of a decoder for implementing a method pursuant to the third aspect of the invention.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

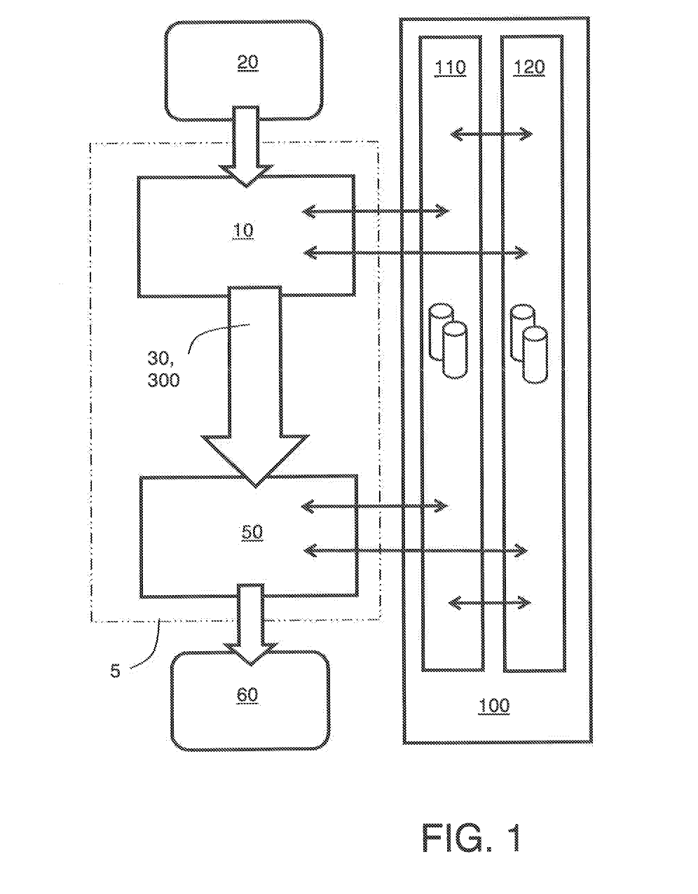

FIG. 1 is a schematic illustration of an encoder and a decoder, namely in combination a codec, pursuant to the present invention;

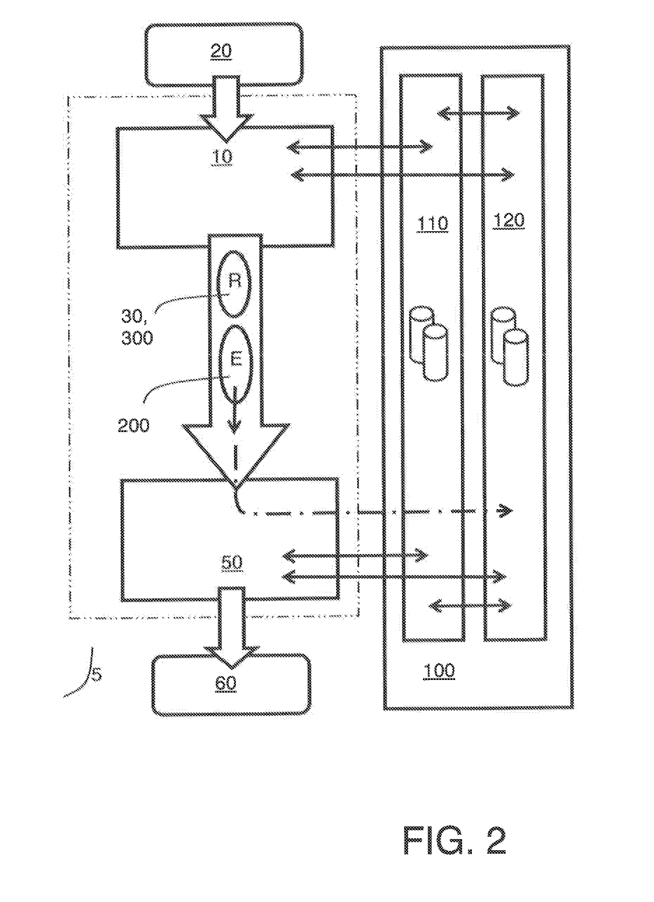

FIG. 2 is a schematic illustration of a new element being sent in the codec of FIG. 1; and

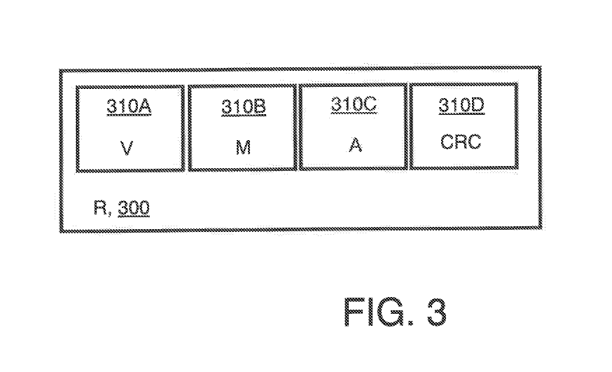

FIG. 3 is a schematic illustration of a multiple separately-defined portions of a reference value communicated within the codec of FIG. 1.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

When describing embodiments of the present invention in the following, abbreviations are employed as provided in Table 1:

TABLE 1
details of acronyms employed to describe embodiments

| Acronym | Detail |
|---|---|
| 1D | 1-Dimensional, for example referring to a signal or data packet |
| 2D | 2-Dimensional, for example referring to a signal or data packet |
| 3D | 3-Dimensional, for example referring to a signal or data packet |
| Block | Multiple data elements from digital data, namely a part of digital data |
| CRC | Cyclic redundancy check |
| Codec | Encoder and decoder for digital data |
| DB | Database in RAM-based or ROM-based memory |
| DC | DC-component of an image, namely an image mean, corresponding to |
| | an average brightness and represents a lowest spatial frequency |
| | present in the image |
| Delta Coding | Delta coding is a way of storing or transmitting data in a form of |
| | differences between sequential data rather than complete data files |
| DCT | Discrete Cosine Transform |
| ISP | Internal Switch Provider |
| LAN | Local Area Network |
| RAM | Random Access Memory |
| RD | Rate-Distortion |
| RLE | Run-Length Encoding |
| ROI | Region of Interest |
| ROM | Read Only Memory |
| VLC | Variable-Length Code |
| XOR | Exclusive Or (logic function) |

In overview, as illustrated in FIG. 1, the present invention is concerned with an encoder 10 for encoding source data 20 to generate corresponding encoded data 30, and a decoder 50 for receiving and decoding the encoded data 30 to generate corresponding decoded data 60; in combination, the encoder 10 and the decoder 50 constitute a codec 5. The decoded data 60 is optionally a representation of the source data, for example at least one of: audio, 1-D images, 2-D images, 3-D images, video content, graphics data. The encoder 10 and the decoder 50 are operable to employ one or more databases 100 for encoding the source data 20 and for decoding the encoded data 30. Moreover, the one or more databases 100 include one or more static databases 110 and/or one or more dynamic databases 120 as will be described in greater detail later.

Embodiments of the present invention beneficially employ techniques as described for an image generator as described in a United States patent application no. US2010/322301 (“Image Processor, Image Generator and Computer Program”; Inventor Tuomas Kärkkäinen; Applicant: Gurulogic Microsystems Oy, 2009) whose contents are hereby incorporated by reference.

In embodiments of the present invention, the one or more dynamic databases 120 and its associated elements E are created when the encoded data 30 is delivered from the encoder 10 to the decoder 50. Moreover, the one or more static databases 110 are beneficially created from the one or more dynamic databases 120, or are delivered earlier before the encoded data 30 is delivered to the decoder 50, or is pre-installed into the decoder 50.

When database elements E are delivered to the decoder 50, they are optionally sent together with a reference value R, partially with a reference value R, or without a reference value R, depending upon coding employed. Beneficially, the encoder 10 and the decoder 50 are operable to compute the entire reference value R, or a part of the reference value R of a given database element E, directly from the data that is to be stored in the given database element E, namely in a manner of a reconstructed data block. Moreover, in respect of the given database element E, an error detection mechanism is implemented, when at least a part of the computed reference value R of the given database element E is delivered between the encoder 10 and the decoder 50.

The encoder 10 and the decoder 50 are beneficially operable to encode and decode respectively data which, at least part, has been encoded pursuant to known encoding standards as provided in Table 2:

TABLE 2
standard encoding standards which are employable in conjunction with
embodiments of the present invention

| | | | |
|---|---|---|---|
| JPEG | JPEG MVC | Lucid | AAC |
| JPEG2000 | MP3 | GIF | FLAC |
| JPEG XR | H.261 | PNG | Ogg Vorbis |
| MPEG-1 | H.263 | TIFF | Speex |
| MPEG-2 | H.264 | BMP | Opus |
| MPEG-4 | WebP | VC-1 | GL12 |
| MPEG-4 AVC | WebM | Theora | |

in FIG. 1, data for the elements E in the one or more databases 100 are encoded for transmission from the encoder 10 to the decoder 50, which enables the delivery of database elements E simultaneously when encoded image data is being delivered. Moreover, encoding of elements E from the one or more databases 100 enables efficient database delivery between the encoder 10 and the decoder 50 namely enabling efficient storage of the database 100 in devices employed, for example, to implement the decoder 50. In an event that the one or more static databases 110 are employed, the encoder 10 and the decoder 50 are made aware of available databases; alternatively, the encoder 10 and the decoder 50 mutually communicate to determine which databases are available for use. Optionally, both the encoder 10 and the decoder 50, by way of mutually dialogue, are operable to define which databases are to be used, prior to encoded data being communicated from the encoder 10 to the decoder 50, wherein the databases are employed for decoding the encoded data 30 at the decoder 50 to generate the decoded data 60.

The encoder 10 and the decoder 50 are beneficially in a large range of practical applications as provided in Table 3, for example in various industries:

TABLE 3
practical application of the encoder 10 and the decoder 50

| | | | |
|---|---|---|---|
| Video | Displays | Satellite systems | Desktop computers |
| communication | | | |
| Security systems | Televisions | Printers | Laptop computers |
| Audio/image/video | Projectors | Scanners, for | In-vehicle crash recorders for |
| streaming services | | example document | recording shortly prior to an |
| | | scanners | accident occurring |
| Medical and | Holographic | Copy machines, | Scientific instruments, for |
| military | projectors | for example | example astronomical |
| applications | | photocopying | telescopes, optical |
| | | machines | microscopes |
| Mobile device | Digital | Sensor nodes | |
| (wireless | cameras | | |
| communication | | | |
| devices), such as | | | |
| pads and cell | | | |
| phones. | | | |

Beneficially, such practical applications as listed in Table 3 beneficially employ an encoder, as described in a published U.S. patent application Ser. No. 13/584,005 which is hereby incorporated by reference, and a decoder, as described in published U.S. patent application Ser. No. 13/584,047.

In overview, the codec of FIG. 1 is operable such that digital data, for example video, image, graphics and audio content, to be communicated from the encoder 10 to the decoder 50 is mostly or completely built from database elements E derived from the one or more databases 100. The databases 100 used can depend upon one or more factors:
(i) the databases 100 used can vary in size, for example are based upon the type of data content being transmitted from the encoder 10 to the decoder 50;
(ii) the databases 100 used can depend upon a required data reconstruction quality at the decoder 50;
(iii) the databases 100 used can depend upon data size to be transmitted from the encoder 10 to the decoder 50; and
(iv) the databases 100 used can depend upon a bandwidth available for transmitting the encoded data 30 from the encoder 10 to the decoder 50.
   Moreover, in the encoded data 30, database references R which are communicated are stored and sent instead of encoded data blocks. To achieve such a manner of data communication from the encoder 10 to the decoder 50, the one or more static and dynamic databases 110, 120 need to be as large as possible. Whereas larger databases require more memory capacity for their storage, such larger databases enable the codec 5 to achieve a better reconstruction quality in the decoded data 60. Beneficially, the codec 5 is operable to select amongst the databases 100 to find a combination thereof which is most appropriate for a given type of data to be communicated in the encoded data 30, for example video, image, graphics and audio content, namely to achieve efficient usage of the databases 100 and a corresponding increased compression ratio. However, it will be appreciated that database reference values R require more data bits when the databases 100 are larger and include more elements E.

For efficient use of the one or more databases 100, there are beneficial generated several static databases 110 for common digital data, for example video, image, graphics and audio content. One or more static databases 110 can be used in conjunction with the encoder 10 for providing data compression in respect of the encoded data 30. For example, a static database 110 is selected depending upon a type of digital data content to be encoded, and the static databases 110 can varying widely according to their size, depending upon memory capacity to be used and also upon required reconstruction quality to be achieved at the decoder 50; the static databases 110 can vary in respect of sizes of data blocks employed, the number of database elements E employed and so forth.

The encoder 10 and the decoder 50 in combination constitute the codec 5 as aforementioned, wherein one or more dynamic databases 120 are beneficially used when communicating data from the encoder 10 to the decoder 50. A dynamic database 120 contains different elements E in comparison to a static database 110, because elements E of the dynamic database 120 are typically created by the encoder 10 when there have not been enough suitable elements in the static database 110 when encoding the source data 20. However, both the encoder 10 and the decoder 50 as aforementioned optionally may need to create dynamic databases 120 during encoding of the source data 20 and decoding of the corresponding encoded data 30, so that compatibility between the encoder 10 and decoder 50 can be guaranteed, and the reconstructed decoded data 60 will substantially match to the source data 20. The one or more dynamic databases 120 are optionally created for temporary use, for example for a defined interval of video frames when the encoded data 30 includes video content; moreover, the one or more dynamic databases 120 are optionally recreated, for example every second, and can be used for a period thereafter for a period of 30 seconds before being erased. The interval optionally varies in a range of few seconds to entire video scenes and movie chapters, for example for minutes of encoded video content. Optionally, it is feasible, pursuant to the present invention, to create a new static database 110 from elements E generated for earlier creating one or more dynamic databases; in other forms, created dynamic databases 120 can be rendered constant in their content and thereafter are operable to function as static databases 110.

The codec 5 pursuant to the present invention, namely comprising the encoder 10 in combination with the decoder 50, regardless of what type of database 100 is employed, whether static or dynamic, is capable in operation of reducing a processing time, namely processing resources and data memory capacity, when storing and transmitting data corresponding to the encoded data 30, for example video, image, graphics and audio content. Such benefit is of great important when the encoded data 30 to be communicated via data communication networks, for example wireless communication networks and the Internet, because the encoded data 30 is less challenging for the communication networks to accommodate, for example in a real-time streamed manner.

In comparison to an image generator as described in a US patent application no. US2010/322,301, the codec 5 in FIG. 1 is capable of providing a greater degree of data compression in the encoded data 30. Such increased data compression is achieved, as illustrated in AG, 2, by communicating a new element E 200 of a dynamic database 120 from the encoder 10 to the decoder 50, without needing to send its corresponding reference value R 210 together with the new element 200. Such a characteristic is accomplished by ail reference values R for the elements E 200 for digital data blocks 220 being susceptible to being recomputed using computing hardware 230 from the reconstructed data block, both in the decoder 50 and in the encoder 10. Optionally, a part of the reference value R beneficially contains information that is otherwise present in both the encoder 10 and the decoder 50, for example derived from how many database elements E are already available in the one or more databases 100

The encoder 10 and the decoder 50 employ a method of computing reference values R which has hitherto not been known. Beneficially, the encoder 10 is operable to reconstruct, namely quantize and de-quantize, data block values before computing corresponding reference values R. For this reason, each data block 220 can be encoded in the encoder 10 using any known lossy or lossless compression algorithm, for example as provided in Table 2, or by a combination of such lossy or lossless compression algorithms; the codec of FIG. 1 can thus be versatile in respect of compression algorithms that it employs which provides major compression benefits. The database elements 200 can also be created for any block size and from any position of a decoded image, for example. Beneficially, the reference values R contain a plurality of component parts that can be computed independently, for example one component describes a mean of block values, another component describes a variance of the block values, yet another component describes an amplitude of the block values, a yet further component describes a check-sum for the block values or the elements E included in a given database 100. Moreover, the entire reference value R, or a part of the reference value R, is also optionally delivered to the decoder 50 together with the encoded data 30; such information is beneficially employed for assessing correctness of delivery, for example any quality degradation resulting in transmitting the encoded data 30 from the encoder 10 to the decoder 50. Optionally, the decoder 50 is operable to return the entire reference value R, or a part thereof, back to the encoder 10.

The aforementioned database reference values require more data bits when the given database 100 is larger. A number of uncompressed data bits require for defining one unique database reference value R can be computed by taking the logo value of the number of elements E 200 in the database 100. Thus, larger database reference values R will require more bits, and the compression ratio achievable in the encoded data 30 is decreased for each existing database data block. Usually, in the database reference value R, there are one or more bits that are reserved for unused data elements E. However, in order to avoid having excessive unused database elements E in a large static database 110, or a dynamic database 120, elements E of a new smaller dynamic database 120 can be created from the elements of a used static database 110, or a used dynamic database 120. The new smaller dynamic database 120 can then be used in the decoder 50 for decoding purposes, wherein the new dynamic database requires fewer bits in its reference values for uniquely identify elements E present in the new small dynamic database in comparison to the larger original database.

The reference value R for the new dynamic database can be, for example, the total number of the elements E present in the new database. Optionally, this reference value R, corresponding to a database element E in the new dynamic database, includes actual data, or it can be linked to another larger database. When the new dynamic database is used for coding the reference values R, it is found that the reference values R can be compressed efficiently by employing a known coding algorithm, for example known delta coding. Thus, using the new dynamic database is capable of saving considerable uncompressed reference value R bits, with substantially no decrease in performance or quality of the decoded data 60 which is output from the decoder 50.

As an example:
(a) if a given static database 110 contains 16 million elements E, expressible using 24-bits of data for the corresponding data values R;
(b) a dynamic database 120 contains only 1024 elements E, expressible using 10 bits of data for the corresponding data values R; and
(c) a data block exists in the dynamic database 120 with a certain data block index,
   then the reference value R will require only 10-bits to define the data block uniquely via the dynamic database 120, compared with 24-bits to define the data block uniquely if it were included in the static database 110. If a given data block is transferred from the static database 110 to the dynamic database 120 in this example, fewer bits are required for uniquely identifying the data block; beneficially, the encoder 10 informs the decoder 50 regarding moving, or copying, of one or more data blocks from the static database 110 to the dynamic database 120. The codec 5 of FIG. 1 is beneficially also optionally capable of operating, such that one or more data blocks are moved, or copied, from the static database 110 to the dynamic database 120 depending upon an amount of database usage occurs for the one or more data blocks. In other words, when encoded reference values R refer to a given data block frequently, the data block at the decoder 50 is beneficially obtained from a given dynamic database 120 transferred to the decoder 50, or made accessible to the decoder 50, rather than from the static database 110 transferred to the decoder 50, or made accessible to the decoder 50.

The codec 5 of FIG. 1 allows for saving bits for database reference values R by creating a small-sized static or dynamic database from the most used database 100 elements of the larger static or dynamic databases 100. In the codec 5, the dynamic databases 120 and/or the static databases 110 of larger size maintain a usage counter for all existing data blocks and new databases are created by selecting elements E as a basis of such usage counter information. Such a smaller database is beneficially created during encoding in the encoder 10, and then communicated or otherwise made available to the decoder 50 for decoding the encoded data 30; such otherwise made available can include, for example, the encoded data 30 including a URL link to the smaller database made available for downloading to the decoder 50 from a remote Internet-based server, for example hosted in a cloud computing environment and accessible to many such decoders 50.

When encoding the source data 20, the encoder 10 is operable at every moment to select how many different databases 100, what kind of databases 100 and which particular databases 100 is to be used to decode the corresponding encoded data 30 when received at the decoder 50, wherein information describing the selection of database 100 made by the encoder 10 is communicated to the decoder 50. Conveniently, the information describing the selection of database 100 is stored in a video header or container of the encoded data 30. Moreover, the decoder 50 is optionally equipped with all of the one or more static databases 110 before executing a task of decoding the encoded data 30. In an event that the decoder 50 discovers that it lacks a given database defined in the encoded data 30, the decoder 50 sends a request to the encoder 10 for the missing given database to be sent, or otherwise made available, for example from a remote network-connected server, to the decoder 50. Optionally, the remote server is located relatively closely to the decoder 50, for example within a mutually similar LAN network, thereby providing fast delivery of missing databases 100 to the decoder 50. Optionally, the missing databases are provided in compressed format to the decoder 50, such that the decoder 50 operates to decompress the missing databases for storage in data memory of the decoder 50. Beneficially, data blocks that are most frequently utilized by the decoder 50 are beneficially stored in a static database 110.

In order to free resources from RAM, either in the encoder 10 or the decoder 50 or both, unused database elements are beneficially removed. Usage of database elements E are beneficially measured by counting the number of used elements E in the database, or by keeping statistics for when the database elements E were last used. In the codec 5 of FIG. 1, all the dynamic databases 120 are processed for clean-up purposes for removing unused elements E. Optionally, the static databases 110 are also subject to cleanup; alternatively, the one or more of the static databases 110 are periodically replaced with new static databases for cleanup purposes. Optionally, old databases 110 can also be transferred to a backup memory so that it can be accessed at a later occasion if necessary for returning to the encoder 10 and/or to the decoder 50, but does not take up memory capacity in the static databases 110; beneficially, the backup memory is implemented via a hard drive, a flash memory, external memory, an optical disc data ROM, a cloud-based data repository and so forth. In operation, the decoder 50 is beneficially notified of any aberrant change in one of the databases 100, for example for enabling the decoder 50 to request an update of its databases 100 to address any such aberration. Beneficially, the databases 100 are also identified by unique identifiers, for example version numbers. If one or more of the databases 100 are changed, for example at the encoder 10, it is desirable that only changes in the databases 100 are communicated to the decoder 50, rather than transferring the entire databases 100 to the decoder 50.

Optionally, the one or more databases 100 can be updated with encoders, for example known types of encoder; moreover, the encoder 10 is optionally provided with an associated preloaded static database 110, for example stored in solid-state ROM. Furthermore, when the one or more dynamic databases 120 are updated in the decoder 50, different modes of updating can be employed; for example:
(i) in a first mode of updating, an old element E is overwritten by a new element E; and
(ii) in a second mode of updating, an old element E is retained, and the new element E is added to increase the size of the one or more dynamic databases 120.
   Optionally, when a small dynamic database 120 is full, namely all elements E thereof allocated, the small dynamic database 120 is inspected, using one or more automated software tools executing upon computing hardware, to determine which elements E of the small dynamic database 120 are used most frequently, and then the elements E within the database 120 are sorted, such that the most frequently used elements E are moved to a beginning of the database 120, for example for rendering the database 120 faster to access for the more frequently used elements E and/or for rendering the database 120 more efficiently compressible, for example for communication from the encoder 10 to one or more decoders 50 via a data communication network, for example Internet or wireless data communication network; beneficially, other less frequently used elements E of the small dynamic database 120 are freed. Both the encoder 10 and the decoder 50 beneficially perform such inspection and sorting when the one or more databases 120 are full. Optionally, such inspection and sorting is initiated by an instruction which is sent out from the encoder 10.

When data storage is initialized, or data transmission is initialized, the encoder 10 is operable to select which of the databases 100 are to be subsequently used by the decoder 50, for example whether or not the databases 100 are empty at commencement of decoding the encoded data 30, or whether or not the databases 100 already contain some database elements E at commencement of decoding the encoded data 30. For example, the decoder 50 optionally commences decoding the encoded data 30 by employing a small generic static database, wherein the decoder 50 proceeds to populate a dynamic database 120 with missing elements E which the encoder 50 determines from data blocks included in the encoded data 30; the dynamic database 120 is then beneficially cleaned up when necessary by using rules as defined in the foregoing. Optionally, the generated dynamic database 120 is stored by the decoder 50 as a new static database 110 for future use when decoding future encoded data 30 received at the decoder 50.

When encoding the source data 20, for example corresponding at least one of video, image, graphics and audio content, the encoder 10 optionally sends database reference values R of a given data block, even if a database including the data block does not yet exist at the decoder 50, for example in an event that the encoder 10 knows that the decoder 50 can fetch a suitable static database 110 including an element E describing the given data block from some static database storage available locally to the decoder 50, for example located on a similar LAN, ISP or other server to the decoder 50. Such an approach enables one encoder 30 to deliver the same encoded data 30 to many decoders 50 that have slightly different databases available to them. When such a method is employed, the decoders 50 do not need to host large static databases or related resources. Thus, the encoder 10 beneficially negotiates with the decoder 50 if such a method can be employed. For the method to be successful, the encoder 10 needs to be aware of public and/or private databases that the decoder 50 is capable of accessing for providing the decoder 50 with the one or more databases 100 that it requires for executing decoding of the encoded data 30 sent from the encoder 10. This method is well suited when there is no need to send encoded data blocks at all, when such supply of data blocks to the decoder 50 from another encoder is feasible, wherein the another encoder has encoded the encoded data earlier. Optionally, the data blocks are communicated from other encoders in a peer-to-peer communication manner. Moreover, the method is suitable for live streaming of encoded video data via the Internet, thereby enabling the encoded video data to be streamed from a long distance remotely from the decoder 50, wherein the data blocks can be sources locally to the decoder 50; in such case, only substantially reference values R are communicated from a location which is the long distance away from the decoder 50.

As aforementioned, the one or more dynamic databases 120 are beneficially contrasted from database elements E which are generated or copied from reconstructed data blocks, either at the encoder 10 or at the decoder 50. The data blocks can be 1-D, 2-D or 3-D, or any combination thereof. Optionally, the data blocks can be size and shape, for example when viewed on a display, for example polygonal, rectangular, elliptical, circular, elongate, triangular to mention a few examples.

Optionally, in respect of the 1-D data block, its shape can be set of one-dimensional data items when presented in the decoded data 60. Moreover, optionally, in respect of the 2-D data block, its shape can be square, a rectangle, a triangle, a parallelogram or a circle when presented in the decoded data 60. Furthermore, in respect of the 3-D data block, its shape can be more polymorphous such as cube, a pyramid, a cylinder, a ball and so forth; such a 3-D data block, for example, is beneficial when the decoded data 60 is intended for 3-D graphic displays, for example for conveying 3-D images for user-viewing. A commonly employed 2-D data block corresponds to 8×8 pixels or similar display elements which is beneficially employed in embodiments of the present invention; there are multiple different and very efficiency known coding methods for 8×8 pixel block sizes which can be utilized by the encoder 10 when generating the encoded data 30.

In order to elucidate the present invention in greater detail, encoding of data blocks in the encoder 10 will now described.

STEP 1:

In an ideal situation, a given database reference value R is computed for a corresponding given data block present in the source data 20, for example for a portion of an image present in the source data 20, if there is suitable existing element E in the one or more databases 100, namely a match is found for the given data block with the existing element E in the one or more databases 100, the reference value R is computed to select the existing element E from the one more databases 100. The match is determined subject to an error between the given data block and the existing data block being below a defined threshold, wherein the defined threshold corresponds to an encoding quality index.

STEP 2:

if a match is made in STEP 1, the reference value R for the selected existing data block is stored or sent, for example in the encoded data 30. The selected existing data block can be searched from a plurality of databases 100, wherein the reference value R stored or sent also includes an identifier of the database 100 wherein the selected existing data block can be found by the decoder 50. Conversely, if a suitable match in STEP 1 cannot be found, then the given data block is encoded, for example using DC-encoding, slide-encoding, multilevel-encoding, DCT-encoder or any other suitable encoding algorithm, and a database reference is computed for the reconstructed data block; the encoded data block is beneficially included in the encoded data 30, for example, for receipt at the decoder 50.

Alternatively, or additional, the encoder 10 is operable to inspect whether or not there is a suitable element E available for the reconstructed data block, similarly as for the source block; in such case, a different encoding quality threshold can be employed. If a certain element is selected to represent the reconstructed data block, its reference value can be stored or sent, for example in the encoded data 30. Alternatively, if a suitable database element E cannot be selected to represent the reconstituted data block, then the reconstructed data block, or the given data block in the source data 20, has to be sent using an encoding algorithm which is most suitable for the reconstituted data block. Beneficially, a method is chosen which generates less bits in the encoded data 30, creates less error, or optimizes used bits for created error, for example by using some lambda coefficient corresponding to RD optimization. This encoded data block can then be added to one or more of the dynamic databases 120 for future use when encoding data at the encoder 10 and/or at the decoder 50.

Optionally, the encoder 10 employs encoding techniques as described in European patent no. EP 1787262 and in European patent application no EP12173534.4 which are hereby incorporated by reference; when employing these techniques as described, for example for encoding video content, a color that represents an unchanged data block can be found in a database 100, or unchanged blocks can be detected and coded differently. Only the changed data blocks require coding using, for example, known coding techniques, for example as provided in Table 2. Similar functionality can be provided for both the encoder 10 and the decoder 50 for optimizing performance in this example based upon the European patent no. EP 1787262 and in European patent application no. EP12173534.4 which are hereby incorporated by reference.

For further elucidating embodiments of the present invention, the databases 100 and aforementioned reference values R will now be described in greater detail; for example, reference is made to United States patent application no. 2010/322,301 which is hereby incorporated by reference. As aforementioned, there are two types of database: static databases 110 and dynamic databases 120. The static databases 110 can be stored in any type of memory; for faster performance, the static databases 110 are optionally stored in ROM, for example ROM can be written or field programmed into a Silicon integrated circuit. Alternatively, or additionally, the static databases 110 are hard-coded into compiled software products recorded on machine-readable data storage media. For example, in embodiments of the present invention, a static database 110 can be created from a dynamic database 120 as aforementioned, and then stored as a corresponding static database 110. Beneficially, the static databases 110 are each identified by unique reference code pertaining thereto. The dynamic databases 120 are always written into RAM, or any equivalent read-write data memory, for example magnetic or optical data storage media such as high-speed magnetic disc data storage.

Optionally, embodiments of the present invention employ “jumping”. Jumping enables missing elements E in a database 100 to be sourced from elsewhere. Moreover, jumping can be employed for both static and dynamic databases 110, 120 respectively. Furthermore, jumping enables dynamic databases 120 to be rapidly updated in respect of missing elements. Beneficially, for such jumping to function efficiently, it is desirable that all data is decoded in a similar order, starting from creation of a database to a current usage time.

The aforesaid reference values R uniquely identify corresponding elements E in a database 100, wherein the elements E represent different types of data blocks. However, it is desirable that the reference values R are generated using a method which is adapted to a type of data content present in the source data 20 which is to be encoded by the encoder 10. In other words, a reference value R is computed in the encoder for each corresponding data block present in portions of the source data 20 or corresponding coded data block. In the encoder 10, the encoded data block represented by its reference value R is reconstructed, namely encoded and then decoded again in the encoder 10, for ensuring that the decoder 50 will be able to generate the same database reference value R for the coded data block which is added to the one or more databases 100. Beneficially, the decoder 50 generated exactly the same one or more databases 100 as employed in the encoder 10 when encoding the source data 20. Various methods can be employed, when implementing embodiments of the present invention, to compute the reference values R, but is beneficially computed from an amplitude, variance, mean and check-sum values pertaining the data blocks present in the source data 20 to be encoded in the encoder 10. “Amplitude” refers, for example, to a difference between the biggest and smallest original data-, or pixel-, values within a given data block. The mean value for a data block is optionally computed from Equation 1 (Eq. 1):

$$M = {\sum }_{i = 1}^{m} {\sum }_{j = 1}^{n} block ( i , j ) \qquad Eq . 1$$

wherein:
M=mean value;
m×n=number of pixels or equivalent present in the data block, for example n=8, m=8 for a 8×8 pixel data block; and
i,j=reference indices.

Moreover, the variance of the data block can be computed using Equation 2 (Eq. 2):

$$V = \frac{1}{m . n} ( ( {\sum }_{i = 1}^{m} {\sum }_{j = 1}^{n} {block [ i , j ]}^{2} ) - {M}^{2} ) \qquad Eq . 2$$

wherein:
V=variance.

Beneficially, the check-sum for the data bock is computed using a logical XOR function against every value, namely pixel in a region of interest (ROI). For example, for static and dynamic databases 110, 120 respectively, the amplitude, the variance V, the mean M and the check-sum as provided in Table 4:

TABLE 4
Example amplitude, variance, mean and check-sum

| Parameter | Example value |
|---|---|
| Amplitude | AMPLITUDE_BITS = 4 |
| Variance | VARIANCE_BITS = 3 |
| Mean | MEAN_BITS = 8 |
| Check-sum | CHECKSUM_BITS = 5 |

For known elements E of a database reference value, pseudo-code computation can, for example, be executed as follows:

DBREF=(AMPLITUDE SHL(DBREF_BITS−AMPLITUDE_BITS))+(VARIANCE SHL(DBREF_BITS−(AMPLITUDE_BITS+VARIANCE_BITS)))+(MEAN SHL(DBREF_BITS−(AMPLITUDE_BITS+VARIANCE_BITS+MEAN_BITS)))+CHECKSUM

A maximum allocated number of bytes of a static or random database 110, 120 respectively is defined the database reference value R. In order to compute a total bit count for a given database reference value R, all elements E must be added where the reference value R is computed, wherein the elements E include the amplitude, the variance V, the mean M and the check-sum, namely MVA combination. For example, the bit count for a database reference value R can be computed as follows:

DBREF_BITS=AMPLITUDE_BITS+VARIANCE_BITS+MEAN_BITS+CHECKSUM_BITS

As a further example, a total size of a given database 100 is computed to be 1,048,576 elements, namely a value 2²⁰, namely approximately 1 Mega-elements. If each element E includes 64 pixels, namely is implemented as an 8×8 data block of pixels, that has 1 byte dynamic range per pixel, then the total size of the uncompressed given database 100 is 64 Mbytes.

As illustrated in FIG. 3, a given reference value R is indicated by 300 and comprises several mutually different portions 310A, 310B, 310C, for example variance V, mean M, amplitude A respectively. These parts are beneficially computed separately, and thus a search in the encoder 10 and/or in the decode 50 can be implemented as rapidly as possible, allowing thereby for fast encoding and/or decoding operations. The different portions 310 beneficially function as separate database sub-references, namely indexes, for example with an addition of a cyclic redundancy check (CRC) as denoted by 310D. Moreover, if a large database 1001s constructed that is based solely on the order of creation, or alternatively on the CRC, it is advantageous for the codec to generate a lookup table as well. This lookup table is beneficially employed to browse a suitable combination of mean M, variance V and amplitude A, in a fast manner.

When computing the reference values R 300, different sampling approaches can be employed, and the reference values R 300 beneficially including additional weighting coefficients, wherein the additional weighting coefficients enable searches amongst fewer alternatives, or it enables the codec to find an element E, for example, borders of images which are less important in respect of decoding quality in a comparison to a central portion of an image; this can be achieved, for example, by employing a dynamically varying quality threshold in the encoder 10 when encoding the source data 20. Searches in the codec 5 can thereby be executed faster because the reference value R includes more precise parameters of data to which they relate; moreover, the CRC or similar index makes it possible to have several database elements E for one basic combination.

Optionally, a search in the one or more databases 100 based upon a given reference value R is executed starting from a large database 100 which contains a reference regarding which elements E and, and in which smaller databases 100, have the same or similar types of elements E. Alternatively, the small database 100 also maintains such information regarding MVA combinations in respect of data that the small database 100 retains; this information enables the smaller database 100 to be ignored rapidly by the encoder 10 and/or the decoder 50 if the combination in the given data block being searched is sufficiently different.

In respect of the aforesaid reference value R, 300, it is optionally advantageous to compress the variance V and the amplitude A together, for example to reduce a total number of bits required to define the reference value R, 300, and hence a reduction in a size of the encoded data 30 needing to be communicated from the encoder 10 to the decoder 50 in FIG. 1; such benefit derives from the variance V and the amplitude A being strongly correlated, Conversely, the mean M and CRC/index portions of the reference value R, 300 are beneficially compressed separately, because the mean M is often compatible with a relatively random delta characteristic and CRC. For a combination of variance V and amplitude A portions that is quantized using fewer bits, it is advantageous to employ Run-Length Encoding (RLE) for generating the encoded data 30; alternatively, delta encoding can be employed for such purpose. If a first given variance V and amplitude A combination is quantized with relatively fewer bits, and a second given variance V and amplitude A combination encoded with more bits in the encoded data 30, it is advantageous that the combinations are encoded separately, for example RLE can be employed for the first given combination, and Huffman coding can be employed for the second given combination.

The reference values R, 300 to be communicated via the encoded data 30 from the encoder 10 to the decoder 50 are beneficially compressed using various compression techniques, for example:
(i) VLC-based methods such as Huffman coding with database coding methods employing Lempel-Ziv algorithms, for example ZLIB, LZO, LZSS, LZ77; and
(ii) Huffman coding or similar for aforesaid combinations of values, for example variance V and amplitude A.
   Optionally, the reference values R, 300 can be compressed as entire values, or parts of the reference values R, 300, for example as illustrated in FIG. 3, can be compressed separately. Moreover, it is optionally feasible to employ a combination of data compression techniques to achieve even greater data compression in the encoded data 30; for example, the variance V portions of the reference values can be firstly compressed using delta coding to generate first compressed data, and then RLE coding techniques can be applied to the first compressed data to generate second compressed data, and then Huffman coding can be applied to the second compressed data to generate third compressed data, wherein the third compressed data is, for example, communicated in the encoded data 30 from the encoder 10 to the decoder 50.

One or more of the databases 100 can contain elements E that consist of the data values of the data blocks in a previously known order, for example in a progressively graded manner. If the order differs from a default order assumed for the codec 5 of FIG. 1, such a differing order is beneficially defined in the encoded data 30 by an order-configuring a parameter. For example, such a sort of data-valued database element E can be created from any right-sized data block, for example from a reconstructed image. Optionally, the parameter can be toggle between states in a course of the encoded data 30 being communicated from the encoder 10 to the decoder 50.

Optionally, the one or more dynamic databases 120 that are updated according to a previously known order employ a flexible number of elements E per frame, for example for enabling the codec 5 of FIG. 1 to achieve a greater data compression ratio for images with relatively less information content. For example, if sizes of a given dynamic database 120 for different frames are 126, 193, 252, 303 elements, then the number of bits required for unique addressing each element for each frame are 7, 8, 8, 9 and 9 bits respectively. In a large database 100, the elements E can be arranged in a (“set number”, “get number”) type of structure, with regard to element E addressing; for example, in a byte of 8-bits, one bit of the byte is reserved for notifying a recipient if the whole value has been transmitted, and the remaining seven bits are used to define the value being sent, optionally with more bits thereafter. By such an approach, it is feasible to transmit seven-bits-worth of information with one byte and fourteen-bits-worth of information in two bytes. Avoiding a need to include bits of information in the encoded data 30 but such an approach is capable of providing enhanced data compression in the codec 5 of FIG. 1.

Optionally, elements included within the one or more databases 100 can be combined, for example to occupy less data memory, or they can contain a sum or coefficient elements, for example for a scaling database 100 or a database 100 with zero mean, which can be computationally adapted using one or more parameters to provide elements E in an appropriate manner when encoding the source data 20 and/or when decoding the encoded data 30. Moreover, the one or more databases 100 can include elements E which have been computed, for example using extrapolation techniques; in other words, the codec has knowledge of a computation method which has been used to generate a given data block and a total size of the given data block, beneficially together with one or more values to provide a basis on which the data values of the data block can be computed. Such computation is beneficially implemented using a DC method and a slide method. The DC method utilizes one value, for example an offset value, that is then applied to all data values within a given data block. Conversely, the slide method, for example implemented as a one-dimensional slide method utilizes two values, for example a first data value and a last data value with the given block, and then computes remaining values for the data block by way of linear interpolation based upon the first and last data values in a linear manner, alternatively in a polynomial manner. Moreover, a two-dimensional slide method is optionally employed which utilizes four values corresponding to corner points in a data block, wherein a remainder of points in the data block are computed using bi-linear interpolation. Furthermore, other types of computational algorithms are optionally employed for computing values for data blocks from relatively few initial values within the codec 5 of FIG. 1.

One or more of the databases 100 optionally include elements E that are references to other databases, for example in a hierarchical manner. In such case, the element E includes information defining another database 100 and also beneficially a reference value for an element E within that other database 100. On a basis of such information, the data values for a given desired data block can be computed. Such a manner of accessing one or more elements E from a secondary database invoked from an element E of a first database beneficially utilizes one or more scaling coefficients and/or one or more pixel value offset shifts, for example if the database element being referred to in the secondary database is of a different size, for example data block size, relative to a desired data block to be returned by invoking the element E of the first database. Beneficially, such an approach employs an Affine model as described in a publication Wikipedia as accessed 19 Oct. 2012 via URL: http://en.wikipedia.org/wiki/Affine_transformation. In Table 5, there is provided an overview of database element types employed for implementing the codec 5 of FIG. 1.

TABLE 5
database element types

| Type | Sub-type | Detailed explanation |
|---|---|---|
| Data-valued elements | | These consist of the data |
| | | values of a data block |
| Computed elements | DC method | These require knowledge of |
| | Slide method | method used and certain key |
| | | values for use in the method |
| References to other databases | These optionally include scaling | These require knowledge of the |
| | coefficients and/or pixel shifts or | method used, together with |
| | transformations | reference values in secondary |
| | | databases |
| Combined elements | These optionally include a sum | These can be employed with |
| | or coefficient elements, for | one or more additional |
| | example a scaling database or | parameters. |
| | a database with zero mean | |
| | value. | |

The present invention has potential widespread application in electronics products that are operable to send and/or receive data representative of various types of content, for example streamed video content, Internet TV, content conveyed via physical data carriers such as optically-readable disks and so forth. Moreover, when the databases 100 are made available only to specific parties, such that substantially mostly reference values R are communicated in the encoded data 30, the present invention can provide data encryption services. Thus, the present invention is applicable in many diverse technical industries.

The encoder 10 and the decoder 50 are beneficially implemented as one or more hardware data processors. Optionally, the hardware data processors are implemented in a hard-wired manner, for example by employing ASIC's or similar digital circuits. Optionally, the hardware data processors are implemented using computing hardware, wherein the computing hardware is operable to execute one or more software products recorded on machine-readable data storage media.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method of encoding source data to generate corresponding encoding data for transmission or storage, wherein the method includes:
(a) matching one or more portions of the source data to one or more elements in one or more databases, wherein the one or more elements are representative of corresponding one or more data blocks, and recording reference values which relate the one or more portions of the source data to the one or more matched elements; and
(b) including the reference values in the encoded data together with the one or more databases and/or information identifying the one or more databases.

2. The method as claimed in claim 1, wherein the source data includes at least one of: audio, video, graphics, multi-dimensional data.

3. The method as claimed in claim 1, wherein the method includes:
(c) receiving the source data in a form of one or more data blocks, dividing the one or more data blocks into areas having a predetermined size and a unique area identifier:
(d) taking area-specific samples from the areas of the one or more data blocks and computing corresponding reference values on a basis of the samples;
(e) storing into a memory or transmitting the reference values for an area and a corresponding area-identifier in an area-specific manner; and
(f) checking whether the reference values obtained as a result of the computations applied to the one or more images have already been stored in the memory or transmitted, and storing into the memory or transmitting the computed reference values and the corresponding area-identifiers for which reference values have been computed in an event that the reference values and the corresponding area-identifiers have not previously been stored into the memory.

4. The method as claimed in claim 1, wherein the one or more databases include one or more static databases and/or one or more dynamic databases.

5. The method as claimed in claim 4, wherein the method utilizes at least one of:
(a) the one or more static databases are generated by selecting elements from one or more dynamic databases;
(b) information present in the one or more portions of the source data is processed to generate one or more elements for inclusion in the one or more dynamic databases; and
(c) selecting elements from one or more earlier dynamic databases and including them in the one or more dynamic databases for use with the encoded data.

6. The method as claimed in claim 1, wherein the reference values include multiple parts which are separately encoded for inclusion in the encoded data.

7. The method as claimed in claim 6, wherein one or more of the multiple parts are combined before being encoded for inclusion in the encoded data.

8. The method as claimed in claim 6, wherein the multiple parts relate to variance V, mean M and amplitude A characteristics of one or more data blocks accessed via use of the reference value.

9. The method as claimed in claim 1, wherein the reference values include information for guiding searching of correspond one or more elements in the one or more databases.

10. The method as claimed in claim 1, wherein the one or more elements include one or more parameters from which one or more corresponding data blocks can be computed by interpolation.

11. The method as claimed in claim 1 wherein the one or more dynamic databases are created for a limited time duration, after which they are erased.

12. The method as claimed in claim 1, wherein the method includes restructuring one or more of the databases as a function of a frequency of accessing elements within the databases for rendering more frequently accessed elements faster to access using the reference values.

13. The method as claimed in claim 1, wherein elements of the one or more dynamic databases are generated when matches of the one or more portions of the source data with one or more elements in the one or more static databases cannot be found.

14. The method as claimed in claim 1, wherein matching of the one or more portions of the source data with one or more elements of the one or more databases is made to within a quality threshold, wherein the quality threshold is dynamically altered during generation of the reference values.

15. The method as claimed in claim 1, wherein the one or more reference values are used to reconstruct one or more corresponding portions of the source data using one or more elements defined by the one or more reference values, and wherein errors are determined between the reconstructed one or more portions and corresponding original one or more portions in the source data, and the errors are encoded and included in the encoded data.

16. The method as claimed in claim 1, wherein one or more data blocks corresponding to the one or more elements are at least one of: 1-D, 2-D or 3-D, polygonal when visually displayed, rectangular when visually displayed, elliptical when visually displayed, circular when visually displayed, elongate when visually displayed, triangular when visually displayed.

17. The method as claimed in claim 1, wherein one or more elements of a first database are operable to refer to one or more elements present in one or more other of the one or more databases.

18. The method as claimed in claim 1 wherein one or more reference values included in the encoded data are in compressed form.

19. The method as claimed in claim 1, wherein the one or more databases are selected and/or are varied in size depending upon a nature of content present in the source data.

20. An encoder for encoding source data to generate corresponding encoding data, wherein the encoder includes:
(a) first data processing hardware for matching one or more portions of the source data to one or more elements in one or more databases, wherein the one or more elements are representative of corresponding one or more data blocks, and recording reference values which relate the one or more portions of the source data to the one or more matched elements; and
(b) second data processing hardware for including the reference values in the encoded data together with the one or more databases and/or information identifying the one or more databases.

21. The encoder as claimed in claim 20, wherein the encoder is operable:
(c) to receive the source data in a form of one or more images, to divide the one or more images into areas having a predetermined size and a unique area identifier;
(d) to take area-specific samples from the areas of the one or more images and to compute corresponding reference values on a basis of the samples;
(e) to store into a memory or to transmit the reference values for an area and a corresponding area-identifier in an area-specific manner; and
(f) to check whether the reference values obtained as a result of the computations applied to the one or more images have already been stored in the memory or transmitted, and to store into the memory or to transmit the computed reference values and the corresponding area-identifiers for which reference values have been computed in an event that the reference values and the corresponding area-identifiers have not previously been stored into the memory.

22. The encoder as claimed in claim 20, wherein the one or more databases include one or more static databases and/or one or more dynamic databases.

23. The encoder as claimed in claim 20, wherein the encoder utilizes at least one of:
(a) the one or more static databases are generated by selecting elements from one or more dynamic databases;
(b) information present in the one or more portions of the source data is processed to generate one or more elements for inclusion in the one or more dynamic databases; and
(c) selecting elements from one or more earner dynamic databases and including them in the one or more dynamic databases for use with the encoded data.

24. The encoder as claimed in claim 20, wherein the first data processing hardware is operable to generate the reference values to include multiple parts which are separately encoded for inclusion in the encoded data.

25. The encoder as claimed in claim 24, wherein the encoder is operable to combine one or more of the multiple parts before encoding them for inclusion in the encoded data.

26. The encoder as claimed in claim 20, wherein the reference values include information for guiding searching of correspond one or more elements in the one or more databases.

27. The encoder as claimed in claim 20, wherein the one or more elements include one or more parameters from which one or more corresponding data blocks can be computed by interpolation.

28. The encoder as claimed in claim 20, wherein the one or more dynamic databases are created for a limited time duration, after which they are erased.

29. The encoder as claimed in claims 20, wherein the encoder is operable to restructure one or more of the databases as a function of a frequency of accessing elements within the databases for rendering more frequently accessed elements faster to access using the reference values.

30. The encoder as claimed in claim 20, wherein elements of the one or more dynamic databases are generated when matches of the one or more portions of the image with one or more elements in the one or more static databases cannot be found.

31. The encoder as claimed in claim 22, wherein matching of the one or more portions of the source data with one or more elements of the one or more databases is made by the first data processing hardware to within a quality threshold, wherein the quality threshold is dynamically altered during generation of the reference values.

32. The encoder as claimed in claim 22, wherein the first data processing hardware is operable to use the one or more reference values to reconstruct one or more corresponding portions of the source data using one or more elements defined by the one or more reference values, and wherein the first data processing hardware is operable to identify errors between the reconstructed one or more portions and corresponding original one or more portions in the source data, and the second data processing hardware is operable to encode the errors and included them in the encoded data.

33. The encoder as claimed in claim 20, wherein the one or more data blocks corresponding to the one or more elements are at least one of: 1-D, 2-D or 3-D, polygonal when visually displayed, rectangular when visually displayed, elliptical when visually displayed, circular when visually displayed, elongate when visually displayed, triangular when visually displayed.

34. The encoder as claimed in claim 20, wherein one or more elements of a first database are operable to refer to one or more elements present in one or more other of the one or more databases.

35. The encoder as claimed in claim 20, wherein one or more reference values included in the encoded data are in compressed form.

36. The encoder as claimed in claim 20, wherein the first data processing hardware is operable to select the one or more databases depending upon a nature of content present in the source data.

37. A method of decoding encoded data to generate corresponding decoded output data, wherein the method includes:
(a) receiving encoded data including reference values and information regarding one or more databases;
(b) decoding from the encoded data the reference values;
(c) accessing one or more elements from the one or more databases as directed by the reference values, wherein the one or more elements are representative of one or more corresponding data blocks; and
(d) generating the one or more data blocks for assembling corresponding decoded data for output.

38. The method as claimed in claim 37, wherein the method includes:
(e) maintaining in a memory reference values and data block information corresponding to the reference values;
(f) receiving or retrieving from a memory area identifiers and a reference value corresponding to each area identifier;
(g) retrieving from the memory on the basis of the reference value of each area identifier data block information corresponding to the reference value; and
(h) generating, on the basis of the data block information retrieved from the memory, a part of a data block to a data block area indicated by the area identifier, on the basis of the reference value corresponding to said area identifier.

39. The method as claimed in claim 37, wherein the one or more databases include one or more static databases and/or one or more dynamic databases.

40. The method as claimed in claim 37, wherein the one or more databases are spatially disposed locally to data processing hardware arranged to execute the method.

41. The method as claimed in claim 39, wherein the one or more databases are hosted in a LAN which also includes the data processing hardware.

42. The method as claimed in claim 37, wherein the method includes generating one or more dynamic databases from one or more elements of the one or more static databases and/or from information provided in the encoded data, wherein the generated one or more dynamic databases are employed for decoding the encoded data.

43. The method as claimed in claim 37, wherein the method includes generating from the one or more elements corresponding one or more data blocks which are at least one of: 1-D, 2-D or 3-D, polygonal when visually displayed, rectangular when visually displayed, elliptical when visually displayed, circular when visually displayed, elongate when visually displayed, triangular when visually displayed.

44. A decoder for decoding encoded data to generate corresponding decoded data, wherein the decoder includes:
(a) first data processing hardware for receiving encoded data including reference values and information regarding one or more databases;
(b) second data processing hardware for decoding from the encoded data the reference values;
(c) third data processing hardware for accessing one or more elements from the one or more databases as directed by the reference values, wherein the one or more elements are representative of one or more corresponding data blocks; and
(d) fourth data processing hardware for generating the one or more data blocks for assembling corresponding decoded data for output.

45. The decoder as claimed in claim 44, wherein the decoder is configured:
(i) to maintain in a memory reference values and data block information corresponding to the reference values:
(j) to receive or to retrieve from a memory area identifiers and a reference value corresponding to each area identifier;
(k) to retrieve from the memory on the basis of the reference value of each area identifier data block information corresponding to the reference value; and
(l) to generate, on the basis of the data block information retrieved from the memory, a part of a data block to a data block area indicated by the area identifier, on the basis of the reference value corresponding to said area identifier.

46. The decoder as claimed in claim 44, wherein the one or more databases include one or more static databases and/or one or more dynamic databases.

47. The decoder as claimed in claim 44, wherein the one or more databases are spatially disposed locally to the data processing hardware of the decoder.

48. The decoder as claimed in claim 44, wherein the one or more databases are hosted in a LAN which also includes the data processing hardware of the decoder.

49. The decoder as claimed in claim 44, wherein the decoder is operable to generate one or more dynamic databases from one or more elements and/or one or more static databases and/or from information provided in the encoded data, wherein the one or more generated dynamic databases are employed for decoding the encoded data to generate the corresponding decoded data.

50. The decoder as claimed in claim 44, wherein the decoder is operable to generate the one or more data blocks from the one or more elements, wherein the one or more data blocks are at least one of: 1-D, 2-D or 3-D, polygonal when visually displayed, rectangular when visually displayed, elliptical when visually displayed, circular when visually displayed, elongate when visually displayed, triangular when visually displayed.

51. A codec including at least one encoder as claimed in claim 20 for encoding source data to generate corresponding encoded data, and at least one decoder as claimed in claim 44 for receiving the encoded data and for decoding the encoded data to generate corresponding decoded data.

52. The codec as claimed in claim 51, wherein the codec is incorporated into one or more consumer electronics products.

53. The codec as claimed in claim 51, wherein the at least encoder and the at least one decoder share one or more databases referred to by reference values included in the encoded data.

54. A software product recorded on machine-readable data storage media, wherein the software product is executable on computing hardware of an encoder for implementing the method as claimed in claim 1.

55. A software product recorded on machine-readable data storage media, wherein the software product is executable on computing hardware of a decoder for implementing the method as claimed in claim 37.
